(19) United States
(12) Patent Application Publication
(10) Pub. No.: US 2021/0321827 A1
(43) Pub. Date: Oct. 21, 2021

(54) COOKING SYSTEM AND COOKING APPLIANCE

(71) Applicant: E.G.O. Elektro-Geraetebau GmbH, Oberderdingen (DE)

(72) Inventors: Carmelo Zarcone, Oberderdingen (DE); Christian Seidler, Bretten (DE)

(21) Appl. No.: 17/210,940

(22) Filed: Mar. 24, 2021

(30) Foreign Application Priority Data
Apr. 21, 2020 (DE) 10 2020 204 999.8

(51) Int. Cl. A47J 44/02; A47J 43/044; A47J 43/06; A47J 36/06; A47J 36/32; A47J 47/01; A47J 43/07

(52) U.S. Cl. CPC A47J 44/02; A47J 43/044; A47J 43/06; A47J 2043/0733; A47J 36/32; A47J 47/01; A47J 43/07; A47J 36/06

(57) ABSTRACT

The invention concerns a cooking system (1) comprising a base module (2) with a drive motor (20) and a drive arm (22), wherein the drive arm (22) has a coupling (21) for releasable connection of a tool (4) to the drive motor (20), and wherein the base module (2) is assigned to a cooking zone (50) of a hob (5), so that the drive arm (22) can be arranged above the cooking zone (50) in order, by means of a tool (4) coupled to the coupling of the drive arm (22), to act on a medium in a container (6) arranged at the cooking zone (50), wherein the base module (2) is arranged on a housing (10), wherein the housing (10) is fitted on the hob (5) so as to be movable in the vertical direction between a stowage position and a usage position, extendable in the horizontal direction, and/or foldable about a pivot axis. The invention furthermore concerns a kitchen appliance with a cooking system (1).

### CROSS-REFERENCE TO RELATED APPLICATIONS

This application claims priority to German Application No. 10 2020 204 999.8, filed Apr. 21, 2020, the contents of which are hereby incorporated herein in its entirety by reference.

### AREA OF APPLICATION AND PRIOR ART

The invention concerns a cooking system comprising a base module with a drive motor and a drive arm, wherein the drive arm has a coupling for releasable connection of a tool to the drive motor, and wherein the base module is assigned to a cooking zone of a hob, so that the drive arm can be arranged above the cooking zone in order, by means of a tool coupled to the coupling of the drive arm, to act on a medium in a container arranged at the cooking zone. The invention furthermore concerns a kitchen appliance with a cooking system.

In order to allow different functions in the preparation of food, private users of kitchens in particular are frequently obliged to use various devices from different suppliers. Over time therefore, private users often accumulate various devices such as scales, hand mixers, toasters, bread machines, coffee/tea machines, fryers etc. In smaller kitchens in particular, this may lead to massive space problems on the worktop. When several devices are to be used simultaneously, their use is sometimes associated with difficulties since the devices are often located at different sites, not enough power outlets are provided, or the spatial conditions only offer limited suitability. Because of the space problems on the worktop, the devices are often stowed in cupboards and for use must first be extracted from the cupboard and assembled.

Furthermore, kitchen devices are offered which contain different functions such as stirring, mixing and weighing, or also cooking and/or simmering functions. These devices however usually take up substantial space.

DE 10 2014 009 195 A1 discloses a kitchen machine with at least one kitchen tool having at least one central unit, wherein at least one extending arm is assigned to the central unit and the extending arm has at least one receiver device for the kitchen tool, and wherein the central unit has means for its fixing in the vicinity of a cooker.

### OBJECT AND SOLUTION

It is an object of the invention to create an improved cooking system and an improved kitchen appliance with a cooking system.

This object is achieved by a cooking system with the features of claim 1 and a kitchen appliance with the features of claim 14. Advantageous embodiments arise from the subclaims.

According to a first aspect, a cooking system is created comprising a base module with a drive motor and a drive arm, wherein the drive arm has a coupling for releasable connection of a tool to the drive motor, and wherein the base module is assigned to a cooking zone of a hob, so that the drive arm can be arranged above the cooking zone in order, by means of a tool coupled to the coupling of the drive arm, to act on a medium in a container arranged at the cooking zone, wherein the base module is arranged on a housing, wherein the housing is fitted on the hob so as to be movable in the vertical direction between a stowage position and a usage position, extendable in the horizontal direction, and/or foldable about a pivot axis.

When not in use, the housing with the base module is thus movable into a stowage position in which the base module is not visible—or at least not visible in such a way as to disrupt the aesthetic impression of a kitchen—and in which the base module is protected from damage or soiling.

Couplings in the context of the application are connecting devices by means of which movements of a drive shaft of the cooking system may be transmitted to an output shaft of the tool or another accessory.

Various kitchen utensils are conceivable as tools, for example stirring spoons, whisks, dough hooks, knives and tongs for gripping ingredients. In some embodiments of the cooking system, the housing comprises a storage device for tools which are not in use. The tools are thus securely stowed when the cooking system is not in use.

In one embodiment, the drive shaft is mounted stationarily and rotationally, wherein during use, a tool coupled to the drive shaft can be rotated about its longitudinal axis by means of the drive motor. In another embodiment, the drive shaft is not mounted stationarily but for example is provided on a planet wheel of a planetary gear mechanism, wherein in addition to its rotational movement about the axis of the output shaft, the tool can be driven in a circulating motion in a circumferential direction of the container.

In the context of the application, the words “one”, “a” etc. are used merely as indefinite articles and should not be interpreted as a number. In particular, in one embodiment, the base model may comprise several drive arms which for example have couplings with rotational axes that are not parallel to one another. Alternatively or additionally, a drive arm may have several couplings. In one embodiment, two couplings are provided on a drive arm for tools used in pairs, such as whisks or dough hooks.

In one embodiment, the drive arm is mounted on the housing so as to be movable between a rest position and a usage position, wherein the drive arm is mounted so as to be pivotable about a horizontal axis and adjustable in the vertical direction. The rest position is selected such that the drive arm is encapsulated as completely as possible in the housing, and the space required for accommodating the drive arm in the housing is minimised. In the usage position, in one embodiment, the drive arm protrudes from the housing so that a coupling of the drive arm may be arranged in the region of the cooking zone above a container arranged there.

In one embodiment, the cooking zone has fixing devices by means of which a container, in particular a cooking pot, can be fixed in the cooking zone. The fixing device comprises for example a magnetic holder.

In another embodiment, additionally or alternatively, a fixing device is provided on the housing of the cooking system, by means of which a container can be fixed in the region of the cooking zone when the housing is in the usage position. The fixing device is thus movable with the housing into a stowage position and, when the cooking system is not in use, is not visible or at least not disruptively visible. In one embodiment, the fixing device has two retaining arms, wherein a container can be clamped between the retaining arms. Alternatively or additionally, in one embodiment, the fixing device comprises a hook on which a handle of the container or similar device can be suspended. In one embodiment, the retaining arms and/or the hook also have magnets for fixing the container. In one embodiment, the fixing device comprises a turning device by means of which a container fixed by the fixing device can be turned or pivoted about an axis as required. In one embodiment, it is provided that the container is pivotable about a horizontal axis for turning the container contents. In other embodiments, the container is pivotable or rotatable about a vertical axis. In order to allow rotation in particular about a vertical axis, in one embodiment it is provided that the container fixed by means of the fixing device is movable in the vertical direction relative to the cooking zone.

In one embodiment, a weighing device is provided, which comprises a vertically movable slide and a weighing cell, wherein for weighing, a container can be moved relative to the cooking zone in the vertical direction by means of the slide, in order to lift the container from the cooking zone. The weighing device, in one embodiment, is part of the fixing device, wherein retaining arms or hooks are provided for fixing the container to the slide. The slide is here preferably mounted such that lever forces, which could adversely affect the weight measurement, are avoided. In one embodiment, the slide is driven by means of the drive motor of the base module. In another embodiment, a separate drive motor is provided for the weighing device.

In one embodiment, a lid is provided on the drive arm, by means of which a container arranged at the cooking zone can be fully or partially covered when the drive arm is in a usage position. In one embodiment, the lid also serves for fixing the container in the cooking zone. In one embodiment, the container can be closed air-tightly and water-tightly by means of the lid, so that cooking by means of steam pressure is possible. The lid here comprises a safety valve. Alternatively or additionally, the lid may be arranged optionally air-tightly and water-tightly or merely resting on the container.

In one embodiment, the cooking system has a device coupling for an additional device which is selected from the non-limited group comprising a mixer, a juice press, a flexible shaft, a vegetable chopper, a mincer, a knife sharpener, a can opener. In one embodiment, the device coupling is provided on the drive arm and coupled to the drive motor of the base module. In another embodiment, alternatively or additionally, a further drive arm is provided, wherein the device coupling is coupled to a separate drive motor or to the drive motor of the first drive arm. In yet another embodiment, alternatively or additionally, the device coupling is arranged stationarily on the housing.

The additional devices may each be designed simply and do not require their own actuators and/or sensors. Here, in particular, it is possible to create additional devices which are compact and suitable for dishwashers. In embodiments of the cooking system, the housing comprises a storage device for the additional devices when not in use.

In one embodiment, the drive motor is activated manually by a user with a tool and/or an additional device connected thereto. In one embodiment, a control element for the tool is here integrated in a user interface of the hob. In one embodiment, a power supply for the drive motor is also provided via a power supply module of the hob.

Alternatively or additionally, a control unit is provided for actuating the drive motor, wherein an operating parameter of the cooking zone is present at the control unit, and the operating parameter can be evaluated for actuating the drive motor. In one embodiment, several operating parameters of the cooking zone are present at the control unit. For example, in one embodiment, it is provided that the drive motor is activated or deactivated, accelerated or decelerated, depending on an energy input at the cooking zone. In one embodiment, precisely one central control unit is provided by means of which both the cooking zone and the drive motor are operated. In other embodiments, several control units are provided, wherein the control units are connected together for data communication. A control unit, at which an operating parameter of the cooking zone can be evaluated for actuation of the drive motor, may advantageously be used both in combination with a movable housing and with a cooking system arranged stationarily.

In one embodiment, by means of the control unit, the drive motor and the cooking zone may be operated fully automatically or semi-automatically for food preparation in a container arranged at the cooking zone according to a cooking programme, wherein preferably the cooking programme is predefinable by means of a user interface. By means of the user interface, a cooking programme stored at the control unit or in a memory unit communicating therewith can be selected. In other embodiments, a cooking programme is predefinable by means of the user interface. In one embodiment, the user interface comprises an input device, in particular in the form of a touch-sensitive display device. Alternatively or additionally, the user interface comprises a hardware connection, in particular a USB port to which an external memory device can be connected, and/or a receiver device for wireless data reception from an external input device such as for example a mobile terminal.

In one embodiment, it is provided that media such as ingredients or additives such as water or similar are manually added to the used container by a user, wherein the user in one embodiment is supported by means of visually or acoustically perceptible signals.

In a further embodiment, a portioning module is provided, wherein the portioning module has a chamber for storage of an ingredient, and wherein the portioning module can be operated by means of the control unit in order to add the at least one stored ingredient to a container arranged at the cooking zone. Preferably, the portioning module has several chambers for storage of different ingredients, wherein the ingredients may be added to the container as required at the start of a cooking process and/or during processing of a cooking programme. This allows a fully automated cooking process without the intervention of the user.

In one embodiment, a monitoring module is provided comprising in particular an optical detection unit, by means of which at least a presence or absence of a container in the cooking zone can be established. In one embodiment, the monitoring module uses sensors present at the cooking zone in order to detect a container.

In one embodiment, by means of the monitoring module a container type and/or a type, quantity, humidity, temperature and/or further composition of the medium in the container can be established. Depending on design, the monitoring module for example serves for detecting a pot and a user, for fully or partly automated turning functions, a fully or partly automated grill-on-point function, for implementing safety functions, for example as protection against overcooking, recipe monitoring etc. In one embodiment, the monitoring module serves for performing vacuum or under-vacuum cooking, wherein a temperature in the container is monitored and controlled or regulated, whereby precise simmering points can be reached.

Depending on the embodiment, the monitoring module comprises suitable sensors and/or imaging systems. An imaging system in one embodiment is a 3D camera system such as a ToF camera. Alternatively or additionally, in one embodiment, a LIDAR system using laser pulses and/or a thermography system is provided. In one embodiment, the sensors are arranged on a lid which may be placed on the container and is arranged on the drive arm, wherein the container arranged at the cooking zone can be covered partially or completely by means of the lid. In one embodiment, the lid is arranged on the drive arm. In other embodiments, the lid is designed as a separate element.

In one embodiment, a display module is provided. The display module is for example a display provided at the hob. In one embodiment, a container content can be visualised on the display module. In other embodiments, the display module serves for visualisation during processing of a cooking programme. Alternatively or additionally, the data may also be transmitted to a mobile terminal. In one embodiment, the display module and the control unit are configured as a common module, wherein a display device of the display module serves as the user interface. Alternatively or additionally, in one embodiment the user interface comprises a hardware connection which allows connection of further devices. In one embodiment, the hardware connection serves to supply power to additional small devices. In other embodiments, the hardware connection serves alternatively or additionally for integration of additional actuators and/or sensors in the cooking system. In one embodiment, the hardware connection is a USB port, wherein the USB port can preferably also be used to connect an external memory device.

In one embodiment, a changeover module is provided, by means of which a tool that can be connected to the coupling can be changed fully automatically or semi-automatically. In one embodiment, the changeover module here comprises a multiaxis robot arm which can independently exchange tools and in some cases also an additional device.

In one embodiment, a water addition module is provided, comprising a water output connection and a water container connected to the water output connection and/or a water connection for a central water supply connected to the water output connection. By means of the water output connection, in one embodiment, water or another liquid may be supplied to the container during performance of a cooking programme. In one embodiment, two water output connections are provided, by means of which water or another liquid with different temperatures can be supplied to the container, wherein to this end a water output connection is connected to the water container via an instantaneous heater for heating the water.

According to a second aspect, a kitchen appliance is provided comprising a hob with a cooking zone and a cooking system, wherein the base module of the cooking system is assigned to the cooking zone such that the drive arm can be arranged above the cooking zone in order, by means of a tool coupled to the coupling of the drive arm, to act on a medium in a container arranged at the cooking zone.

In one embodiment, the hob is an induction hob. In another embodiment, a glass ceramic hob is provided. In one embodiment, the cooking zone comprises a weighing device.

### BRIEF DESCRIPTION OF THE DRAWINGS

Further advantages and aspects of the invention arise from the claims and the following description of preferred exemplary embodiments of the invention which are explained below with reference to the schematic figures. The drawings show:

FIG. 1 in a perspective depiction, a first exemplary embodiment of a cooking system comprising a base module assigned to a cooking zone,

FIGS. 2(a) to (0 in a front view, the cooking system from FIG. 1 in various positions on transfer from a stowage position to a usage position,

FIG. 3 in a perspective depiction, a second exemplary embodiment of a cooking system comprising a base module assigned to a cooking zone,

FIG. 4 in a front view, a cooking system similar to FIG. 3, and

FIG. 5 in a side view, the cooking system according to FIG. 4.

The same reference signs are used in the figures for the same or similar components.

### DETAILED DESCRIPTION OF THE EXEMPLARY EMBODIMENTS

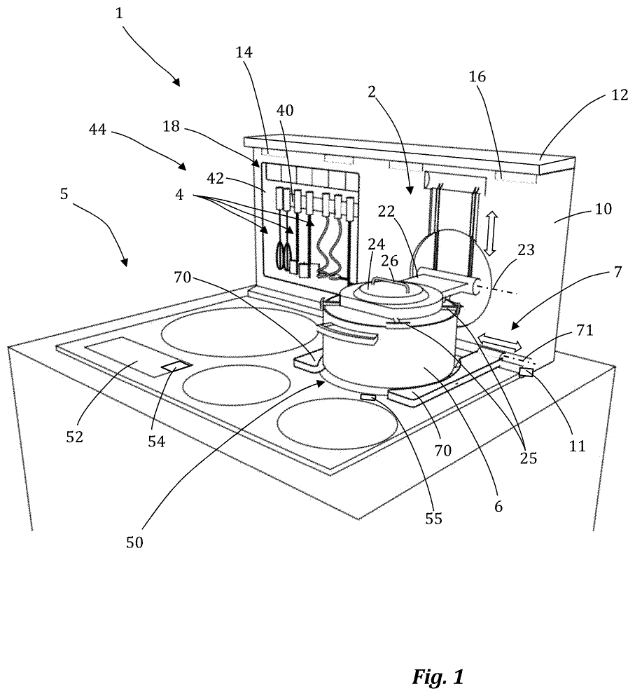

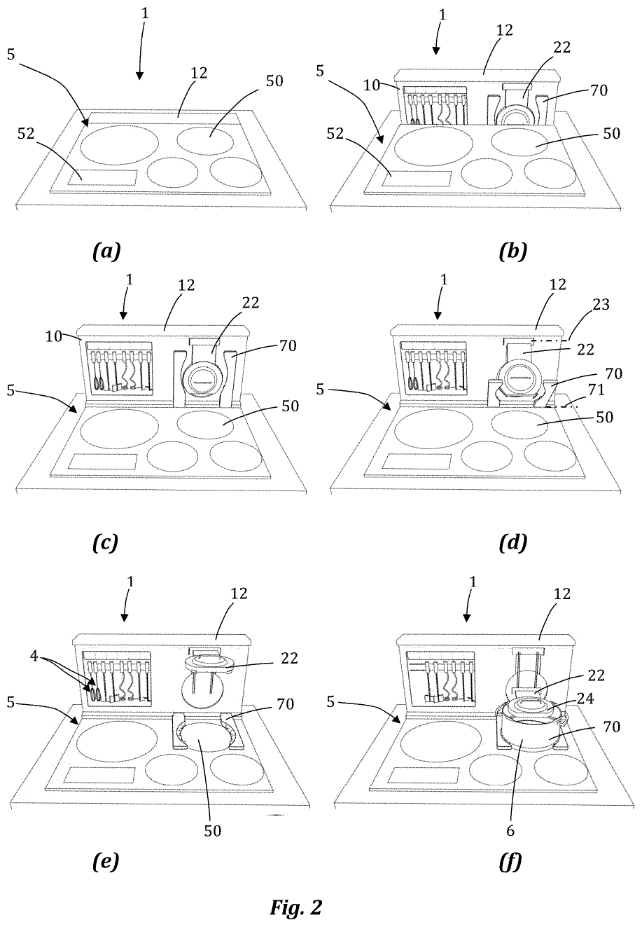

FIGS. 1 and 2 shows schematically a first exemplary embodiment of a cooking system 1 comprising a base module 2 with a drive motor (not visible in FIGS. 1 and 2) and a drive arm 22. The drive motor serves to drive various tools 4 which can be coupled interchangeably to the drive motor for kneading, stirring or similar. The drive arm 22 to this end has a coupling (also not visible in FIG. 1) for connecting a selected tool 4 to the drive motor. In the exemplary embodiment shown, the drive arm 22 is mounted on a housing 10 so as to be pivotable about a horizontal axis 23 and—as indicated schematically by a double arrow—adjustable in the vertical direction. In another embodiment, the drive arm 22 is mounted on the housing so as to be pivotable about a vertical axis.

The base module 2 is assigned to a cooking zone 50 of a hob 5, i.e. the base module 2 is arranged relative to the cooking zone 50 such that a tool 4 arranged on the drive arm 22 can cooperate with a container 6 placed on or in the cooking zone 50, in order for the tool 4 to act on a medium in the container 6 so as to process the medium. The tool 4 is for example stirring or dough hooks which may be used in pairs, wherein the tool pair is also designated a tool 4 in the context of the application.

For safe processing, the cooking system 1 comprises a fixing device 7 by means of which the container 6 may be fixed in the region of the cooking zone 50. In the exemplary embodiment shown, the fixing device 7 comprises two retaining arms 70 which are arranged on either side of the container 6, and are mounted on the housing 10 so as to be pivotable about a horizontal pivot axis 71 and—as indicated schematically by an arrow—displaceably along the pivot axis 71.

In one embodiment, the fixing device 7 for the container 6 cooperates mechanically with the container 6, wherein in the exemplary embodiment illustrated, the retaining arms 70 of the fixing device 7 each comprise recesses adapted to the shape of a conventionally used container 6. In addition or alternatively, in one embodiment, the container 6 and the fixing device comprise toothing elements which intermesh by form fit for fixing the container 6.

In one embodiment, the fixing device 7 for the container 6 comprises at least one permanent magnet (not shown) and/or an electromagnet. In one embodiment, several permanent magnets are provided which are arranged in a so-called Halbach array. A Halbach array is a linear arrangement of permanent magnets which allows the magnetic flux to be almost eliminated on the one side of the arrangement but strengthened on the other. To this end, the permanent magnets are each tilted by 90° in the direction of the longitudinal axis of the array relative to the adjacent permanent magnets. In this way, the magnetic fields interfere so that the field lines on one side are drawn closer together, causing an increase in the magnetic flux density on this side. On the opposite side, the field lines are not as close as in undisrupted magnets, therefore the field here is weakened even at a small distance. This prevents disruptive attraction forces acting on elements outside the cooking zone 50 by means of the fixing device 7. For separation, in one embodiment, the container 6 and the fixing device 7 are movable in a direction transverse to the direction of the attraction forces. In an alternative embodiment, at least one switchable electromagnet is provided.

In the exemplary embodiment illustrated, the drive arm 22 has a lid 24 which can be placed on the container 6. Clamping arms 25 are provided on the depicted lid 24, and are adjustable in the radial direction of the lid 24 so as to fix the lid 24 to an upper edge of the container 6. For manual movement of the clamping arms 25 for fixing the lid 24, the lid 24 illustrated has a handle 26, which for example is rotatable about a vertical axis for adjusting the clamping arms 25. In one embodiment, the lid 24 can be applied to the container 6 air-tightly and water-tightly, so that for example cooking by means of steam pressure is possible. The lid 24 here has a safety valve (not shown) which may safely dissipate any excess pressure in the container 6.

In one embodiment, the container 6 is a conventional cooking pan of a commercially standard size. In other embodiments, the container 6 is adapted to the cooking system 1.

In the exemplary embodiment shown, a storage device 44 is provided on the housing 10 for tools 4 which are not in use. In the exemplary embodiment depicted, the storage device 44 comprises a magnetic holding rail 40 on which tools 4 may be held by a magnetic or magnetisable portion. In the exemplary embodiment shown, in the region of the magnetic retaining rail 40, a trim 42 is provided which is made from a material that is easy to clean, for example stainless steel.

In the cooking system 1 depicted, further functions are also integrated which are useful in the region of a hob 5. In the exemplary embodiment depicted, these functions are a light 14 and a fume extractor 16, which are each arranged at an upper end on the housing 10, and a storage system 18 for ingredients or herbs with several chambers, for example in the form of drawer insert units.

As described in detail below with reference to FIG. 2, in the exemplary embodiment shown, the housing 10 is fitted on the hob 5 so as to be movable in the vertical direction between a stowage position and a usage position, wherein the housing 10 is mounted so as to be lowerable, i.e. adjustable in the vertical direction, behind the hob 5. A terminating plate 12 is provided on an upper end of the housing 10. A design of the terminating plate 12 may be adapted to the design of the hob 5, so that when it is not in use and the housing 10 is lowered, an aesthetically pleasing solution is created in which the cooking system 1 is not visible and is securely protected from undesired access and/or soiling. To prevent trapping of objects and/or limbs when the housing 10 is lowered, preferably a safety device 11 is provided which comprises for example a trap protection, a light barrier or similar.

An operating device 52 is provided on the hob 5. In an advantageous embodiment, the cooking system 1 can also be operated by means of this operating device 52. In one embodiment, the control panel 52 is connected to a control unit 54 (depicted schematically) by means of which a temperature at the cooking zone 50 and/or the drive motor for driving the tool 4 coupled therewith can be controlled and/or regulated. In one embodiment, the control device 52 also functions as a display module, by means of which at least an activation of the cooking zone 50 can be displayed to a user. In one embodiment, the control unit 54 is configured such that the base module 2 and cooking zone 50 can be operated fully automatically or semi-automatically for food preparation in a container 6 fixed to the cooking zone 50. In one embodiment, a resistance of the medium present in the container 6 against a movement of a tool 4 acting on the medium is detected. The detected resistance is fed back to the control unit 54. The detected resistance can thus be evaluated by the control unit 54, in order for example to adapt a temperature of the cooking zone 50 and/or a rotational speed of the tool 4.

Finally, in the exemplary embodiment shown, a weighing device 55 is also provided at the hob 5, by means of which the weight of the container 6 can be monitored. The weighing device 55 allows a simple control for the addition of ingredients. Furthermore, by means of the weighing device 55, the food being prepared can be monitored. To this end, the weighing device 55 is preferably connected to the control unit 54 for data transmission. Alternatively or additionally, in one embodiment, weighing cells are provided on the retaining arms 70. In one embodiment, the hob 5 is configured as an induction hob, wherein the container 6 can be held by means of the retaining arms 70 at least temporarily spaced from the cooking zone 50 for a weighing process, without interrupting a heat supply for a cooking process. In one embodiment, it is provided that the container 6 remains lifted by means of the retaining arms 70 for the entire cooking process or for a defined phase in a cooking process, wherein by means of the weighing device 55, a change in weight can be established and thus monitoring of the food preparation is possible. Thus for example, from a weight loss because of evaporation, it can be established that a liquid in the container 6 is boiling. Alternatively or additionally, a so-called boil-dry function is implemented by means of the weighing device 55 as protection against overheating, wherein a constant weight despite heat supply leads to the conclusion that a liquid present in the container 6 has completely evaporated. In order then to avoid an impending overheating, in one embodiment an energy supply to the cooking zone 50 is interrupted.

FIGS. 2(a) to (f) show in a front view the cooking system 1 with a hob 5, and a cooking system 1 according to FIG. 1 in various positions on transition of the housing 10 from a stowage position shown in FIG. 2(a) to a usage position shown in FIG. 2(f).

As described above, in the exemplary embodiment depicted, the housing 10 of the cooking system 1 is movable in the vertical direction, and thus the cooking system 1 can be lowered behind the hob 5 into the stowage position shown in FIG. 2(a), wherein only the terminating plate 12 is visible. The terminating plate 12 preferably lies flush with the hob 5, and in colour and shape is adapted to the hob 5 or a worktop surrounding the hob 5.

The cooking system 1 can be transferred from the stowage position shown in FIG. 2(a) into the usage position shown in FIG. 2(f). To this end, in one embodiment, a motorised drive (not shown in FIG. 2) is provided. The motorised drive can be activated for example by means of the control panel. In other embodiments, a manual adjustment device is provided wherein in one embodiment, a spring device is provided, in particular comprising a gas compression spring, which supports a user in an adjustment movement.

As shown in FIGS. 2(b) and 2(c), in the exemplary embodiment depicted, the retaining arms 70 of the fixing device 7 and the drive arm 22 lie against a rear wall of the housing 10 during the movement of the housing 10.

As soon as the housing 10 is fully extended, the drive arm 22 and retaining arms 70 may each be pivoted about the assigned horizontal axis 23 or 71, until the drive arm 22 and the retaining arms 70 extend at least substantially parallel to the hob 5, as shown in FIG. 2(e).

Next, a container 6 shown in FIG. 2(f) may be placed on the hob and fixed by means of the fixing device 7, wherein to this end the arms 7 are moved along the pivot axis 71. Furthermore, a tool 4 or a tool pair may be taken from the storage device and coupled to the drive arm 22. The drive arm 22 with attached tool 4 may then be moved in the vertical direction and the lid 24 fixed to the container 6, as shown in FIG. 2(f).

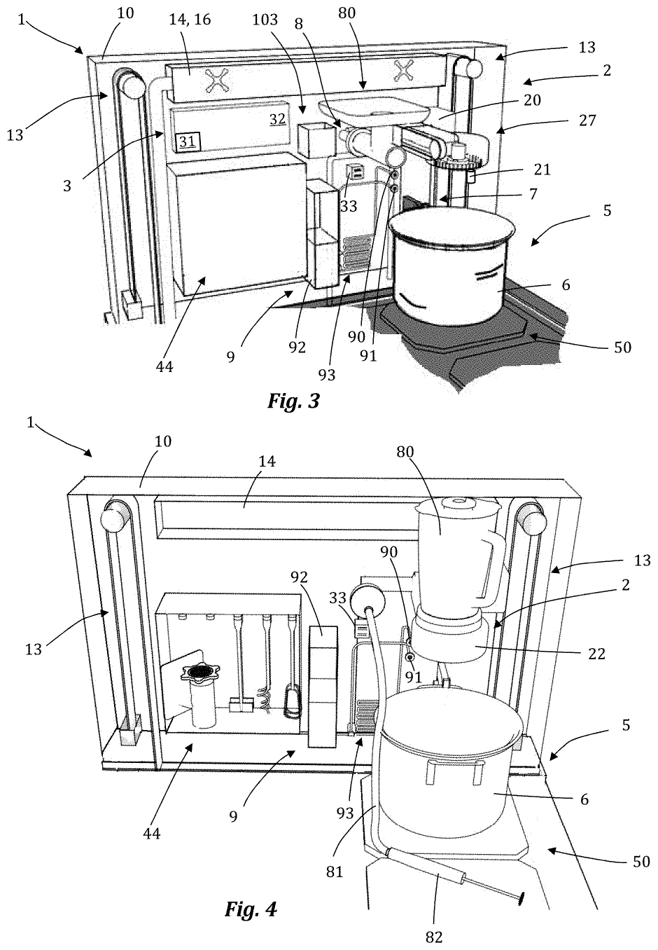

FIG. 3 shows in a perspective depiction a second exemplary embodiment of a cooking system 1 comprising a base module 2 which is assigned to a cooking zone 50 of a hob 5. The base module 2 has a drive motor 20 and a drive arm 22 with a planetary gear mechanism 27 driven by means of the drive motor 20, wherein a tool (not shown in FIG. 3) can be coupled to the planetary gear mechanism 27 by means of a coupling 21 which is depicted schematically. The coupling 21 is designed for example as a push-fit coupling.

The base model 2 is arranged on a housing 10, wherein the housing 10 can be moved in the vertical direction between a stowage position and a usage position. To this end, in the exemplary embodiment depicted, a belt drive 13 is provided on both sides of the housing 10. In one embodiment, the two belt drives 13 may be driven in synchrony with each other by means of a respective drive motor (not shown). In other embodiments, a synchronisation shaft is provided, by means of which both belt drives 13 may be driven.

A light 14 and a fume extractor 16, combined in a common unit, are provided on the housing 10 illustrated.

A fixing device 7 is provided on the housing 10, and in the exemplary embodiment depicted comprises a hook on which a handle (not shown) of the container 6 may be suspended.

The cooking system 1 shown in FIG. 3 also has a device coupling 8 for an additional device 80. The additional device 80 is for example a mincer. However other additional devices are also conceivable. The device coupling 8 in the exemplary embodiment depicted comprises a drive shaft which can rotate about a horizontal axis running perpendicularly to a rear wall of the housing 10. A storage device 44 for additional devices 80 and/or tools 4, which are not in use, is provided on the housing 10 depicted in FIG. 3.

In contrast to the exemplary embodiment 2 shown in FIG. 1, with the cooking system 1 according to FIG. 3, a control module 3 with a control unit 31 and a display module 32 is provided on the housing 10. The control unit 31 serves to actuate the drive motor of the base module 2. The control unit 31 in one embodiment communicates with a control unit of the hob 5, so that an operating parameter of the cooking zone 50 is present at the control unit 31 and the operating parameter can be evaluated for actuating the drive motor of the base module 2. In other embodiments, the hob 5 is controlled or regulated by means of the control unit 31. By means of the control unit 31, the drive motor and the cooking zone 50 may be operated fully automatically or semi-automatically for food preparation in the container 6 arranged at the cooking zone 50, in accordance with a cooking programme. The cooking programme may be predefined by means of a user interface. In one embodiment, the user interface is provided by the display module 32, which to this end has a touch-sensitive surface. Also, in the exemplary embodiment depicted, a hardware connection 33, in particular a USB port, is provided for a data carrier.

The cooking system 1 shown in FIG. 3 furthermore comprises a monitoring module 103. By means of the monitoring module 103, at least the presence or absence of a container 6 in the cooking zone 50 can be established. To this end, in one embodiment, the monitoring module 103 comprises an imaging system (not shown).

Furthermore, the cooking system 1 shown in FIG. 3 has a water addition module 9 with two water output connections 90, 91 and a water container 92 connected thereto. Here, one water output connection 90 is connected to the water container 92 by means of an instantaneous heater 93 (indicated merely diagrammatically), so that water with a higher temperature and/or steam may be made available at this water output connection 90.

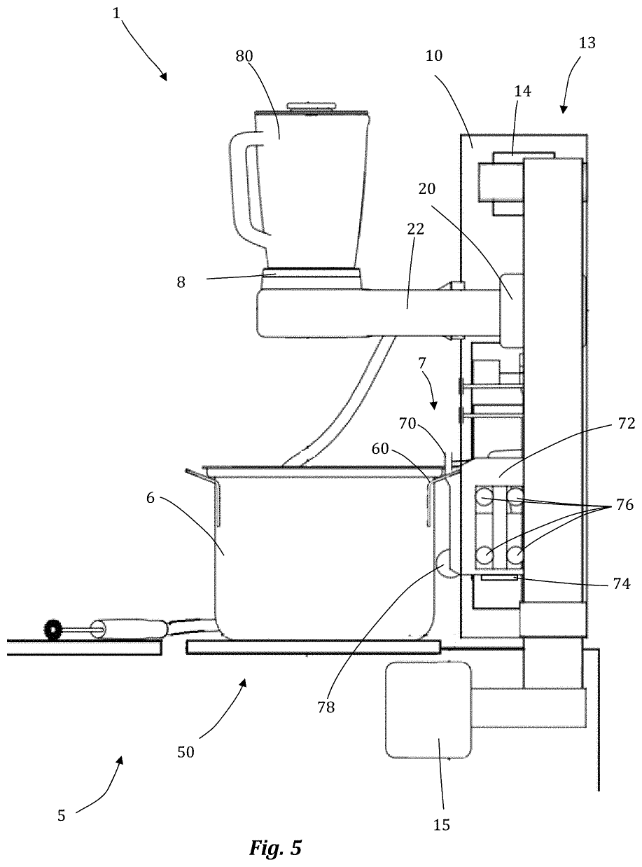

FIGS. 4 and 5 show a front view and side view respectively of a cooking system similar to that of FIG. 3, wherein for a detailed description of elements already described, reference is made to the above.

In contrast to the exemplary embodiment shown in FIG. 3, the exemplary embodiment shown in FIGS. 4 and 5 has neither a control module 3 nor a monitoring module 103. In one embodiment, the drive motor 20 of the base module 2 (depicted schematically in FIG. 5) is controlled by means of a control unit of the hob (see FIG. 1).

Also, in contrast to the exemplary embodiment in FIG. 3, only a light 14 and not a fume extractor is provided on the housing 10. Here, a conventional extractor hood serves as a fume extractor.

The drive arm 22 shown in FIGS. 4 and 5, on its side facing away from the cooking zone 50 in the usage position depicted, has a device coupling 8 (see FIG. 5) on which, in the exemplary embodiment depicted, an additional device 80 in the form of a mixer is attached.

In the exemplary embodiment shown, a flexible shaft 81 is arranged on the device coupling 8 arranged on the housing 10, at the end of which shaft a rotating tool 82 is arranged. This serves for example for foaming a medium in a container.

In one embodiment, a flap (not shown) is provided on the schematically depicted storage device 44, by means of which the storage device can be closed.

As evident in FIG. 5, drive motors 15 for the belt drives 13 provided on both sides of the housing 10 are arranged below a user surface of the hob 5.

As further evident in FIG. 5, the fixing device 7 comprises a hook 70 on which a handle 60 of the container 6 is suspended. The hook 70 is provided on a slide 72 which is vertically movable. In the exemplary embodiment shown, the slide 72 is part of a weighing device which furthermore comprises a weighing cell 74. The slide 72 is mounted movably by means of at least two, in the exemplary embodiment depicted by means of four, symmetrically arranged rollers 76. Also, a supporting roller 78 for the container 6 is provided on the slide 72 below the hook 70. For a weighing process, the container 6 is moved vertically relative to the cooking zone 50 by means of the slide 72, in order to lift the container 6 from the cooking zone 50. For a movement of the slide 72, in one embodiment, the slide 72 is permanently or temporarily coupled to the drive arm 22 and can be moved therewith in the vertical direction. In another embodiment, an additional drive motor is provided for an adjustment movement of the slide 72. Because the slide 72 is supported by means of the weighing cell 74 and the rollers 76, it is ensured that any lever forces do not—or at least not substantially—hinder a weighing function.

It is evident to the person skilled in the art that the tools 4 and additional devices 80 shown in the figures are merely exemplary, and neither the invention nor the exemplary embodiments depicted are restricted to use with the tools and/or additional devices depicted.

The exemplary embodiments depicted are merely exemplary, and numerous derivatives are conceivable for implementing a cooking system according to the invention. In particular, elements discussed in connection with one exemplary embodiment may be combined with elements of other exemplary embodiments in order to obtain further exemplary embodiments.

In one embodiment, a drive arm is provided which has two or more axes and two or more members linked via joints.

Furthermore, apart from the modules and elements depicted, further devices are conceivable. In one embodiment, the cooking system comprises a pressing module which may be used for preparing pastries or biscuits. In one embodiment, a pressing module has a pressing head which allows a mass to be “pressed” onto a baking tray, for example. In one embodiment, the pressing module comprises a multiaxis arm for high flexibility.

Alternatively or additionally, in one embodiment, a changeover module is provided by means of which a tool 4 which can be connected to the coupling 21, and/or an additional device which can be connected to the device coupling 8, can be exchanged fully automatically or semi-automatically.

1. Cooking system comprising a base module (2) with a drive motor (20) and a drive arm (22), wherein the drive arm (22) has a coupling (21) for releasable connection of a tool (4) to the drive motor (20), and wherein the base module (2) is assigned to a cooking zone (50) of a hob (5), so that the drive arm (22) can be arranged above the cooking zone (50) in order, by means of a tool (4) coupled to the coupling of the drive arm (22), to act on a medium in a container (6) arranged at the cooking zone (50), characterized in that the base module (2) is arranged on a housing (10), wherein the housing (10) is fitted on the hob (5) so as to be movable in the vertical direction between a stowage position and a usage position, extendable in the horizontal direction, and/or foldable about a pivot axis.

2. Cooking system according to claim 1, characterized in that the drive arm (22) is mounted on the housing (10) so as to be movable between a rest position and a usage position, wherein the drive arm (22) in particular is mounted so as to be pivotable about a horizontal axis (23) and adjustable in the vertical direction.

3. Cooking system according to claim 1, characterized in that a fixing device (7) is provided on the housing (10), by means of which a container (6) can be fixed in the region of the cooking zone (50) when the housing (10) is in the usage position.

4. Cooking system according to claim 1, characterized in that a weighing device is provided, which comprises a vertically movable slide (72) and a weighing cell (74), wherein for weighing, a container (6) can be moved relative to the cooking zone (50) in the vertical direction by means of the slide (72) in order to lift the container (6) from the cooking zone (50).

5. Cooking system according to claim 1, characterized in that a lid (24) is provided on the drive arm (22), by means of which a container arranged at the cooking zone (50) can be fully or partially covered when the drive arm (22) is in a usage position.

6. Cooking system according to claim 1, characterized in that the cooking system has a device coupling (8) for an additional device (80) which is selected from the group comprising a mixer, a juice press, a flexible shaft, a vegetable chopper, a mincer, a knife sharpener, a can opener.

7. Cooking system according to claim 1, or according to the preamble of claim 1, characterized in that a control unit (31, 54) is provided for actuating the drive motor (20), wherein an operating parameter of the cooking zone (50) is present at the control unit (31, 54), and the operating parameter can be evaluated for actuating the drive motor (20).

8. Cooking system according to claim 7, characterized in that by means of the control unit (31, 54), the drive motor (20) and the cooking zone (50) may be operated fully automatically or semi-automatically for food preparation in a container (6) arranged at the cooking zone (50) according to a cooking programme, wherein preferably the cooking programme (6) is predefinable by means of a user interface.

9. Cooking system according to claim 7, characterized in that a portioning module is provided, wherein the portioning module has a chamber for storage of an ingredient, and wherein the portioning module can be operated by means of the control unit (31, 54) in order to add the stored ingredient to a container (6) arranged at the cooking zone (50).

10. Cooking system according to claim 1, characterized in that a monitoring module (103) is provided comprising in particular an optical detection unit, by means of which at least a presence or absence of a container in the cooking zone can be established, wherein preferably by means of the monitoring module a container type and/or a type, quantity, humidity, temperature and/or further composition of the medium in the container can be established.

11. Cooking system according to claim 1, characterized in that a display module (32, 52) and/or a hardware connection (33) is/are present.

12. Cooking system according to claim 1, characterized in that a changeover module is provided, by means of which a tool that can be connected to the coupling can be changed fully automatically or semi-automatically.

13. Cooking system according to claim 1, characterized in that a water addition module (9) is provided, comprising a water output connection (90, 91) and a water container connected to the water output connection (90, 91) and/or a water connection for a central water supply connected to the water output connection (90,91).

14. Kitchen appliance comprising a hob with a cooking zone and a cooking system according to claim 1, wherein the base module is assigned to the cooking zone such that the drive arm can be arranged above the cooking zone in order, by means of a tool coupled to the coupling of the drive arm, to act on a medium in a container arranged at the cooking zone.

15. Kitchen appliance according to claim 14, characterized in that the cooking zone (50) comprises a weighing device (55).
